(19) United States
(12) Patent Application Publication
(10) Pub. No.: US 2025/0363490 A1
(43) Pub. Date: Nov. 27, 2025

(54) SYSTEMS AND METHODS FOR PREVALIDATING TRANSACTIONS

(71) Applicant: Wells Fargo Bank, N.A., San Francisco, CA (US)

(72) Inventors: Michael Knorr, Fairfield, CT (US); Sumit Tripathi, San Francisco, CA (US)

(73) Assignee: Wells Fargo Bank, N.A., San Francisco, CA (US)

(21) Appl. No.: 18/674,620

(22) Filed: May 24, 2024

(51) Int. Cl. G06Q 20/40

(52) U.S. Cl. CPC G06Q 20/40

(57) ABSTRACT

Systems and methods are described herein for prevalidating transactions using application programming interfaces (APIs). Such systems and methods may use a provider computing system to receive a transaction request from a user device associated with a user account held by a provider associated with the provider computing system. The user account may include account information, and the transaction request may include first transaction data and second transaction data. The provider computing system may determine an objective of the transaction request based on the account information. The provider computing system may perform a first verification including verifying, using a first API, the first transaction data based on the account information. The provider computing system may perform a second verification including verifying, using a second API, the second transaction data based on the objective. The provider computing system may validate the transaction request based on the first verification and the second verification.

### TECHNICAL FIELD

The present disclosure relates to systems and methods for prevalidating transactions. More specifically, the present disclosure relates to using use-specific applications programming interfaces (APIs) to ensure that payment information is accurate and in agreement with a user's intended objective regarding the payment.

### BACKGROUND

Ensuring payment accuracy requires extensive checks and procedures, especially with regard to aligning correct purpose codes and to mitigating fraud risks associated with a transaction. Therefore, users may experience significant delays while awaiting transaction validation or transactions being executed contrary to their intent.

### SUMMARY

An embodiment relates to a provider computing system. The provider computing system includes a processing circuit having a processor coupled to a memory device. The memory device stores instructions thereon that, when executed, cause the processing circuit to perform operations including: receiving a transaction request from a user device associated with a user account held by a provider associated with the provider computing system, the user account including account information, and the transaction request including first transaction data and second transaction data; determining an objective of the transaction request based on the account information; performing a first verification including verifying, using a first application programming interface (API), the first transaction data based on the account information; performing a second verification including verifying, using a second API, the second transaction data based on the objective; and validating the transaction request based on the first verification and the second verification.

Another embodiment relates to a method. The method includes: receiving, by a provider computing system, a transaction request from a user device associated with a user account held by a provider associated with the provider computing system, the user account including account information, and the transaction request including first transaction data and second transaction data; determining, by the provider computing system, an objective of the transaction based on the account information; performing, by the provider computing system, a first verification including verifying, using a first application programming interface (API), the first transaction data based on the account information; performing, by the provider computing system, a second verification including verifying, using a second API, the second transaction data based on the objective; and validating, by the provider computing system, the transaction request based on the first verification and the second verification.

Another embodiment relates to a non-transitory computer-readable medium storing instructions that, when executed, cause a processing circuit to receive a transaction request from a user device associated with a user account held by a provider associated with a provider computing system, the user account including account information, and the transaction request including first transaction data and second transaction data; determine an objective of the transaction request based on the account information; perform a first verification including verifying, using a first application programming interface (API), the first transaction data based on the account information; perform a second verification including verifying, using a second API, the second transaction data based on the objective; and validate the transaction request based on the first verification and the second verification.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 depicts a block diagram of a system for prevalidating transactions using application programming interfaces (APIs), according to an example embodiment.

FIG. 2 depicts a block diagram of an AI sub-system of the system of FIG. 1, according to an example embodiment.

FIG. 3 depicts a block diagram of an AI model of the AI sub-system of FIG. 2, according to an example embodiment.

FIG. 4 depicts a method of prevalidating transactions using APIs, according to an example embodiment.

FIG. 5 depicts a graphical user interface (GUI) for prevalidating transactions using APIs, according to an exemplary embodiment.

FIG. 6 depicts another GUI for prevalidating transactions using APIs, according to an exemplary embodiment.

### DETAILED DESCRIPTION

Referring generally to the figures, systems and methods for prevalidating transactions using application programming interfaces (APIs) are disclosed. The systems and methods disclosed herein use artificial intelligence (AI) to determine an objective or other parameter associated with a transaction. The determined objective, for example, may provide one or more indications of a validity of a transaction request. That is, based on the objective, the systems and methods described herein allow for a plurality of APIs to determine whether additional parameters associated with the transaction (e.g., a payee, a transaction amount, a transaction method, etc.) align with the determined objective.

The implementations described herein address a technical problem by providing enhanced data integration and analysis capabilities, which deliver a particular technical solution that streamlines and refines validation of transactions based on a payor's purpose with regard to the transaction. The systems and methods described herein are implemented to improve how data is synthesized and utilized from various sources that provide information relating to the payor's purpose and to the transaction. By integrating data related to the payor's purpose, these systems and methods provide proactive validation actions relating to transactions. For example, the implementations can provide a prevalidation of a transaction that is aligned with a payor's intended purpose for the transaction. Accordingly, this approach provides a specific technical improvement to various technical problems, including those set forth herein.

The prevalidation and verification of transactions based on a payor's intended purpose can facilitate the management of an account associated with the payor, leveraging data analytics to proactively monitor transactions and account data. By applying machine learning models, the systems and methods can detect patterns and predict outcomes based on a large amount of data inputs, such as transaction histories and third-party data. This can improve transaction validation such that models are not only based on past transactions but are continuously updated, trained, and provided to a user to detect verified transactions proactively and effectively. Accordingly, the models trained and implemented herein provide technological improvements over existing business ecosystems by providing real-time, adaptive response mechanisms that tailor validation strategies based on current data insights. That is, these improvements are realized by implementing real-time data integration and dynamic interpretation, enhancing both the speed and accuracy of validation actions. For example, lack of real-time data integration is a technical problem in existing technological ecosystems, which is solved by the technical solution of implementing adaptive machine learning models.

In some arrangements, the systems and methods can act as intermediaries that assess real-time transactions to monitor for abnormal activity. For example, if a scheduled transaction includes a receiving party that is unrelated to a payor's intended purpose for the transaction, the systems and methods can immediately identify the scheduled transaction and display the abnormal activity prominently among a plurality of transactions associated with the user. These models can identify vulnerabilities and security issues in transactions across multiple accounts and can also be configured to display the information from multiple accounts on a single user interface to provide operational efficiency for a controller/manager/owner of the multiple accounts. By analyzing transactional and third-party data, such as transaction histories, invoice documents, industry data, and so on, the systems and methods can validate transactions before the transactions occur.

The systems and methods described herein may also reduce processing power and improve bandwidth by implementing a user-specific cluster of application programming interfaces (APIs) that are working simultaneously in the back end to validate transactions for a specific user, rather than implanting a plurality of APIs operating individually and consuming unnecessary processing power. With the systems and methods described herein, the APIs that are relevant to a user are working simultaneously to validate transactions and may provide the user with an end result (e.g., a transaction validation), rather than providing intermittent results as individual parameters of a transaction are validated by individual APIs. Furthermore, the systems and methods as described herein generate new processes for a user to adopt in order to comply with various industry standards for transactions. That is, the systems and methods as described herein are trained to identify industry-specific parameters for transactions performed in a particular industry, therefore ensuring that transactions are compliant with the industry standards prior to attempting to process the transactions. This validation with industry standards reduces processing power by avoiding multiple attempts to process a non-compliant transaction and validating compliance of a transaction before it is processed.

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

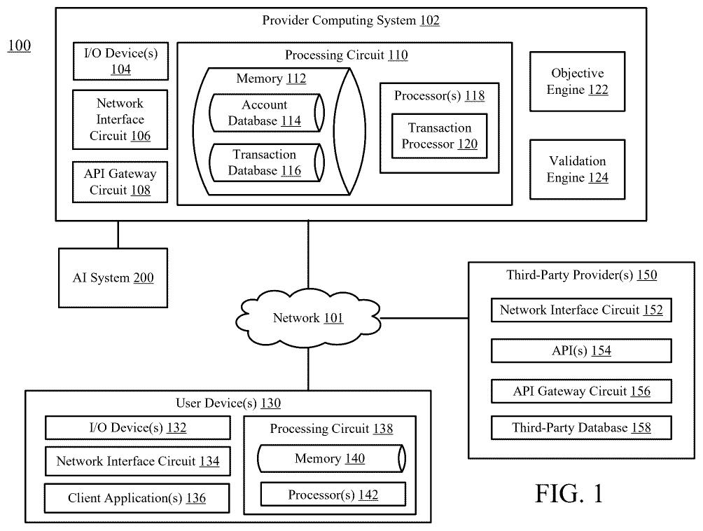

FIG. 1 is a diagram of a system 100 for prevalidating transactions using APIs, according to an example embodiment. As shown, the system 100 includes a provider computing system 102 communicably coupled to one or more user device(s) 130 and one or more third-party provider(s) 150. The provider computing system 102 is owned by, associated with, or otherwise operated by a provider (e.g., a service provider, a bank, or other financial institution). The provider may maintain one or more accounts held by various customers, such as demand deposit accounts, credit card accounts, receivables accounts, and so on. Similarly, the one or more third-party provider(s) 150 may be owned by, associated with, or otherwise operated by a provider (e.g., a service provider, a bank, or other financial institution) that maintains one or more accounts held by various customers. The provider computing system 102, the one or more user device(s) 130, and the one or more third-party provider(s) 150 are in communication with each other and are connected by a network 101.

The network 101 can include any type or form of one or more networks. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the Asynchronous Transfer Mode technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

In some instances, the provider computing system 102 may be embodied by one or more servers, each with one or more processing circuits (e.g., processing circuit 110) having one or more processors (e.g., processor(s) 118) configured to execute instructions stored in one or more memory devices (e.g., memory 112) to send and receive data stored in the one or more memory devices and perform other operations to implement the methods described herein associated with logic or processes shown in the figures. In some instances, the provider computing system 102 may include and/or have various other devices communicably coupled thereto, such as, for example, desktop or laptop computers (e.g., tablet computers), smartphones, wearable devices (e.g., smartwatches), and/or other suitable devices.

In some embodiments, the provider computing system 102 includes one or more I/O devices 104, a network interface circuit 106, and an API gateway circuit 108. The one or more I/O devices 104 are configured to receive inputs from and display information to a user. While the term “I/O” is used, it should be understood that the I/O devices 104 may be input-only devices, output-only devices, and/or a combination of input and output devices.

In some instances, the network interface circuit 106 includes, for example, program logic that connects the provider computing system 102 to the network 101. For example, in some instances, the program logic interfaces with one or more transceivers (e.g., Bluetooth, Wi-Fi, or any other suitable communication transceivers) to enable connection with the network 101. The network interface circuit 106 facilitates secure communications between the provider computing system 102, each of the user device(s) 130, and each of the third-party provider(s) 150. The network interface circuit 106 also facilitates communication with other entities, such as other banks or financial institutions, settlement systems, and so on. The network interface circuit 106 further includes user interface program logic configured to generate and present web pages to users accessing the provider computing system 102 over the network 101.

In some embodiments, the provider computing system 102 includes the API gateway circuit 108. In some embodiments, external devices (e.g., the user device(s) 130 and/or the third-party provider(s) 150, etc.) may include and/or execute API protocols that are used to establish an API session between the provider computing system 102 and the external devices. In this regard, the API protocols and/or sessions may allow the provider computing system 102 to communicate content and data (e.g., one or more services offered by the provider computing system 102) to be displayed/provided/rendered directly within the external devices. For example, the external device may activate an API protocol (e.g., via an API call), which may be communicated to the provider computing system 102 via the network 101 and the network interface circuit 106. The API gateway circuit 108 may receive the API call from the network interface circuit 106, and the API gateway circuit 108 may process and respond to the API call by providing API response data. The API response data may be communicated by the provider computing system 102 to the external device via the network interface circuit 106 and the network 101. The external device may then access (e.g., display/use/interface with) the API response data (e.g., one or more services offered by the provider institution) on the external device.

As such, the API gateway circuit 108 is structured to initiate, receive, process, and/or respond to API calls (e.g., via the network interface circuit 106) over the network 101. That is, the API gateway circuit 108 may be configured to facilitate the communication and exchange of content and data between the external devices and the provider computing system 102. Accordingly, to process various API calls, the API gateway circuit 108 may receive, process, and respond to API calls using other circuits. Additionally, the API gateway circuit 108 may be structured to receive communications (e.g., API calls, API response data, etc.) from other circuits. That is, other circuits may communicate content and data to the provider computing system 102 via the API gateway circuit 108. Therefore, the API gateway circuit 108 is communicatively coupled to other circuits of the provider computing system 102, either tangibly via hardware, or indirectly via software.

The provider computing system 102 is shown to include the processing circuit 110, including memory 112 and processor(s) 118. The processing circuit 110 may be structured or configured to execute or implement the instructions, commands, and/or control processes described herein with respect to the memory 112 and/or the processor(s) 118.

The memory 112 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The memory 112 may be or include tangible, non-transient volatile memory or non-volatile memory. The memory 112 may also include database components, object code components, script components, or any other type of information structure for supporting the activities and information structures described in the present application.

In some embodiments, the memory 112 may include an account database 114. The account database 114 is structured or configured to retrievably store customer account information associated with various customer accounts held or otherwise maintained by the provider institution on behalf of its customers. In some instances, the customer account information includes both customer information and account information pertaining to a given customer account. For example, in some instances, the customer information may include a name, a phone number, an e-mail address, a physical address, an occupation, etc. of the customer associated with the customer account. In some instances, the account information may include transaction information, information pertaining to the type and corresponding capabilities of the given account, a transfer service token (e.g., a phone number, an e-mail address, or a tag associated with a particular transfer service account) associated with the customer account, etc. of the customer account.

As shown in FIG. 1, the memory 112 may include a transaction database 116. The transaction database 116 may be configured to store transactions associated with a user of the provider institution. In some embodiments, the stored transactions may include a transaction history of past transactions. Alternatively or additionally, the transaction database 116 may store upcoming transactions that are scheduled to occur in the future. For example, the transaction database 116 may receive the upcoming transactions from the client application 136 as an input from the user device 130. The transaction database 116 may be configured to store, with each of the transactions, transaction data associated with each transaction. For example, the transaction database may store a transaction amount, a transaction method, a date of completion, one or more parties, a purpose code, and so on, associated with each stored transaction.

The processing circuit 110 is also shown to include processor(s) 118. The processor(s) 118 may be implemented or performed with a general-purpose single-or multi-chip processor, a digital signal processor (DSP), an application specific integrated circuit (ASIC), one or more field programmable gate arrays (FPGAs), or other suitable electronic processing components. A general-purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the processors 118 may be shared by multiple circuits (e.g., the circuits of the processor(s) 118 may comprise or otherwise share the same processor which, in some example embodiments, may execute instructions stored, or otherwise accessed, via different areas of the memory 112). Alternatively or additionally, the processor(s) 118 may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

In some embodiments, the processor(s) 118 may include a transaction processor 120. The transaction processor 120 may be structured or configured to enable and monitor various customer transactions (e.g., the customer sending funds to a payee, the customer receiving funds from a payor). In some instances, the transaction processor 120 is further structured to incorporate at least some of the functionalities offered by the third-party provider 150 (e.g., via one or more APIs 154 and/or SDKs of the third-party provider 150) to allow for customers to send and receive transfers of funds using transfer service tokens (e.g., via a client application 136 provided to the user device 130 by the provider computing system 102). Accordingly, in some instances, the transaction processor 120 is further structured to enable and monitor various transactions and/or transfer service fund transfers conducted by the customers. In some instances, the transaction processor 120 is structured to, for each transaction performed by each customer of the provider, automatically pull customer account information associated with the customer (e.g., from the account database 114), as well as sender/recipient account information associated with the sender and/or recipient (e.g., from the transaction database 116, from the third-party database 158, etc.), associated with a particular transaction.

The provider computing system 102 may also include an objective engine 122 and a validation engine 124. The objective engine 122 is structured or configured to determine an objective of a transaction request. The objective engine 122 may determine the objective of the transaction request based on account information (e.g., stored in the account database 114) associated with a user account. For example, the objective engine may determine the objective of a transaction request based on a transaction history associated with the user account, an entity category (e.g., an industry) with which the user account is associated, personal information associated with the user account, and so on. In some embodiments, the objective engine 122 may determine the objective associated with the transaction request based on third-party data (e.g., received from the third-party provider(s) 150). For example, the provider computing system 102 may be configured to receive/access one or more invoices associated with the user account from a third-party provider 150. As another example, the provider computing system 102 may be configured to receive reports, journals, articles, or other publications providing information relating to an industry associated with the user account (e.g., stored in the third-party database 158).

The validation engine 124 is structured to validate a transaction request based on a verification of transaction data associated with the transaction request. In some embodiments, the validation engine 124 may be configured to receive the verification of transaction data from a plurality of APIs (e.g., API(s) 154) each configured to provide verification of one or more of the transaction data. For example, a purpose code API may be configured to verify that a purpose code associated with a transaction request relates to a determined objective associated with the transaction request. The validation engine 124 may then receive at least one of a successful verification of the purpose code to identify that the purpose code does relate to the determined objective, or a failed (e.g., unsuccessful) verification of the purpose code to identify that the purpose code does not relate to the determined objective. In some embodiments, the validation engine may be configured to provide instructions to the provider computing system 102 and/or the third-party provider 150 regarding whether the transaction request may be processed or held based on the verification (e.g., as described below with reference to method 400).

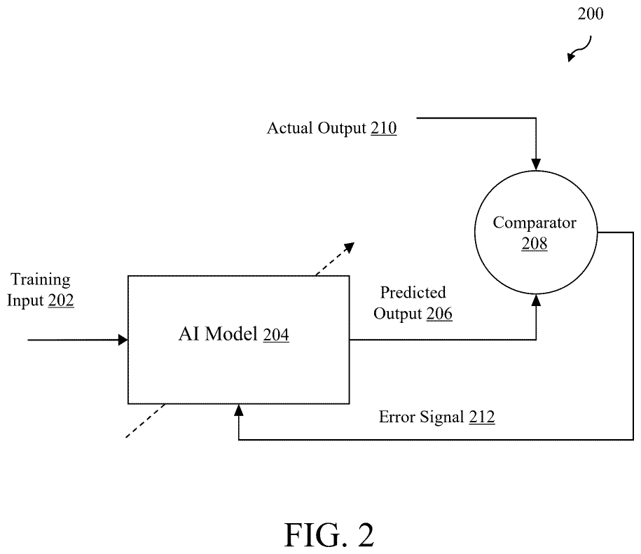

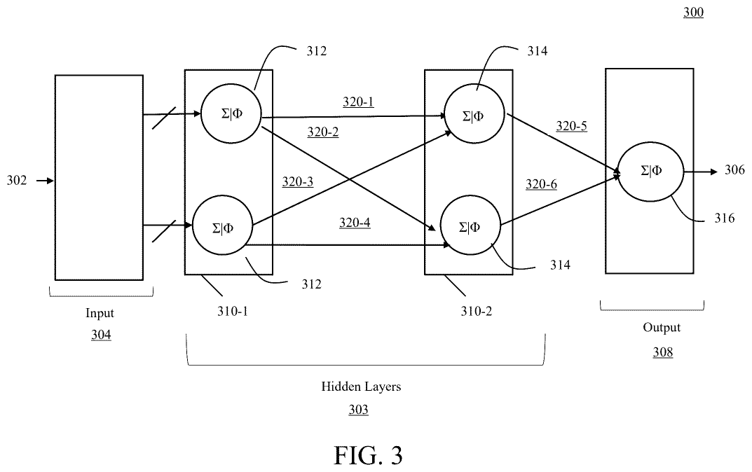

In some embodiments, the provider computing system 102 includes the AI system 200, as described below with reference to FIGS. 2 and 3. Alternatively, the AI system 200 may be remote to the provider computing system 102. For example, in some embodiments, the AI system 200 is separate from the provider computing system 102, and may communicate with the provider computing system 102 via one or more networks, such as the network 101. The AI system 200 may be configured to receive internal data stored by the provider computing system 102 (e.g., from the memory 112). In some embodiments, the AI system 200 receives inputs from the user device(s) 130 via the provider computing system 102 (e.g., received by the network interface circuit 106). The provider computing system 102 may also be configured to retrieve data from the third-party provider(s) 150 to provide to the AI system 200 (e.g., as training inputs 202, as actual outputs 210, etc.).

The user device 130 is owned, operated, controlled, managed, and/or otherwise associated with a user, such as an employee of the provider (e.g., a banker, analyst, or other employee that works on managing financial accounts), a client/customer of the provider (e.g., a person associated with an entity having one or more accounts with the provider), or a third party. In some embodiments, the user device 130 may be or may include, for example, a desktop or laptop computer (e.g., a tablet computer), a smartphone, a wearable device (e.g., a smartwatch), a personal digital assistant, and/or any other suitable computing device.

In some embodiments, the user device 130 includes one or more I/O devices 132, a network interface circuit 134, one or more client applications 136, and a processing circuit 138. While the term “I/O” is used, it should be understood that the I/O devices 132 may be input-only devices, output-only devices, and/or a combination of input and output devices.

In some instances, the I/O devices 132 include various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the user to provide inputs (such as a touchscreen display, stylus, keyboard, force sensor for sensing pressure on a display screen, etc.). In some instances, the I/O devices 132 further include one or more user interfaces (devices or components that interface with the user), which may include one or more biometric sensors (such as a fingerprint reader, a face scanner, an iris scanner, etc.).

The network interface circuit 134 includes, for example, program logic and various devices (e.g., transceivers, etc.) that connect the user device 130 to the network 101. For example, in some instances, the program logic interfaces with one or more transceivers (e.g., Bluetooth, Wi-Fi, or any other suitable communication transceivers) to enable connection with the network 101. The network interface circuit 134 facilitates secure communications between the user device 130 and the provider computing system 102. The network interface circuit 134 also facilitates communication with other entities, such as other banks, settlement systems, and so on (e.g., the third-party provider(s) 150, etc.).

In some embodiments, the user device 130 stores in computer memory (e.g., memory 140), and executes (“runs”) using one or more processors (e.g., processor(s) 142), various client applications 136, such as an Internet browser presenting websites, text messaging applications, and/or applications provided or authorized by entities implementing or administering any of the computing systems in the system 100. For example, in some instances, the client applications 136 include a provider client application (e.g., a financial institution banking application) provided by and at least partly supported by the provider computing system 102. For example, in some instances, the client application 136 coupled to the provider computing system 102 enables the user to perform various activities associated with a transaction.

The processing circuit 138 includes a memory 140 and processor 142. The memory 140 may be one or more memory or storage devices (e.g., RAM, ROM, Flash memory, hard disk storage) for storing data and/or computer code for completing and/or facilitating the various processes described herein. Memory 140 may be or include non-transient volatile memory, non-volatile memory, and non-transitory computer storage media. Memory 140 may include database components, object code components, script components, or other types of information structured for supporting the various activities and information structures described herein. The memory 140 may be coupled to the processor 142 and may include computer code or instructions for executing one or more processes described herein. The processor 142 may be implemented as one or more processors, application specific integrated circuits (ASICs), field programmable gate arrays (FPGAs), a group of processing components, or other suitable electronic processing components. As such, the user device 130 is configured to run a variety of application programs and store associated data in the memory 140. For example, one such application may be the client application 136.

The system 100 is further shown to include one or more third-party provider(s) 150. The third-party provider(s) 150 may include one or more institutions (e.g., financial institutions) where a user has one or more accounts. The third-party provider(s) 150 may include a network interface circuit 152, one or more API(s) 154, an API gateway circuit 156, and a third-party database 158.

The third-party provider(s) 150 may include the network interface circuit 152, which may be similar/identical to the network interface circuit 106 of the provider computing system 102 and/or to the network interface circuit 134 of the user device 130, as described above. For example, the network interface circuit 152 includes program logic and various devices (e.g., transceivers, etc.) that connect the third-party provider(s) 150 to the network 101. In some instances, the program logic interfaces with one or more transceivers (e.g., Bluetooth, Wi-Fi, or any other suitable communication transceivers) to enable connection with the network 101. The network interface circuit 152 facilitates secure communications between the third-party provider(s) 150 and the provider computing system 102. The network interface circuit 152 also facilitates communication with other entities, such as other banks, settlement systems, customers, and so on (e.g., the provider computing system 102, the user device(s) 130, etc.).

In some embodiments, the third-party provider(s) 150 may include the one or more API(s) 154 communicably coupled to/managed by/or otherwise associated with the third-party provider(s) 150. In some embodiments, the one or more API(s) 154 may be an API associated with one or more programs, services, applications, etc., offered by the third-party provider(s) 150 to one or more users enrolled in such corresponding one or more programs, services, applications, etc.

The third-party provider(s) 150 may include the API gateway circuit 156, which may be similar/identical to the API gateway circuit 108 of the provider computing system 102, as described above. For example, the third-party provider(s) 150 may activate the API protocol, which may be communicated to the provider computing system 102 via the network 101 and the network interface circuits 106/152 of the provider computing system 102/third-party provider 150, respectively.

Third-party database 158 may store third-party data associated with the third-party provider 150 (e.g., a transaction history, an invoice, industry data, etc.). In some embodiments, the data stored in the third-party database 158 may be provided to the provider computing system 102, the user device(s) 130, and/or to additional third-party providers 150. In some arrangements, the third-party database 158 can be structured to collect data from other devices connected via the network 101 (e.g., the user device(s) 130 and/or the provider computing system 102) and relay the collected data to the provider computing system 102 and/or user device 130.

Referring to FIG. 2, a block diagram of the AI system 200 is shown. The AI system 200 may include at least one AI model 204. In some embodiments, AI system 200 employs one or more of supervised learning, unsupervised learning, semi-supervised learning, reinforcement learning, self-supervised learning, transfer learning, deep learning, ensemble learning, instance-based learning, decision tree learning, batch learning, or online learning to train the AI model 204.

In some embodiments, the AI system 200 employs supervised learning, which is a method of training a machine learning model (e.g., the AI model 204) given input-output pairs, where an input-output pair is an input with an associated known output (e.g., an expected output). In some embodiments, the AI system 200 employs unsupervised learning, which is a method of training a machine learning model (e.g., the AI model 204) where the model is presented with unlabeled data and must identify patterns or structures within it using techniques such as clustering or dimensionality reduction. In some embodiments, the AI system 200 employs semi-supervised learning, which is a method of training a machine learning model (e.g., the AI model 204) using a combination of supervised and unsupervised learning where the model is trained on a dataset with both labeled and unlabeled examples. In some embodiments, the AI system 200 employs reinforcement learning, a method of training a machine learning model (e.g., the AI model 204) where an agent interacts with data and receives feedback in the form of rewards or penalties and the agent learns to take actions that maximize cumulative rewards over time. In some embodiments, the AI system 200 employs self-supervised learning, which is a method of training a machine learning model (e.g., the AI model 204) where the model generates its own labels from the input data. In some embodiments, the AI system 200 employs transfer learning, which is a method of training a machine learning model (e.g., the AI model 204) which involves training a model on one task and then leveraging the learned features for a different but related task. In some embodiments, the AI system 200 employs deep learning, which is a method of training a machine learning model (e.g., the AI model 204) involving neural networks with multiple layers. In some embodiments, the AI system 200 employs ensemble learning, which is a method of training a machine learning model (e.g., the AI model 204) which involves combining multiple models to improve overall performance and robustness, commonly using techniques such as bagging (e.g., Random Forests) and boosting (e.g., AdaBoost). In some embodiments, the AI system 200 employs instance-based learning, which is a method of training a machine learning model (e.g., the AI model 204) which involves making predictions based on similarities between new instances and instances in the training dataset, commonly using k-Nearest Neighbors (k-NN) algorithms. In some embodiments, the AI system 200 employs decision tree learning, which is a method of training a machine learning model (e.g., the AI model 204) which involves using a tree-like model of decisions and their possible consequences, where each node in the tree represents a decision based on input features. In some embodiments, the AI system 200 employs batch learning, which is a method of training a machine learning model (e.g., the AI model 204) where the model is trained on the entire dataset at once. In some embodiments, the AI system 200 employs online learning, which is a method of training a machine learning model (e.g., the AI model 204) where the model is updated continuously as new data arrives, allowing for real-time adaptation.

The AI model 204 may be trained based on general data and/or granular data (e.g., data based on a specific user) such that the AI model 204 may be trained specific to a particular user (e.g., a user with a customer account at the provider institution). In some instances, the granular data refers to at least one of data from an internal data source (e.g., the memory 112) or external data source(s) (e.g., the memory 140, the third-party database 158, etc.).

The training inputs 202 and the actual outputs 210 may be provided to the AI model 204 as a training dataset. The training dataset refers to data used to train the AI model 204 to generate predicted transaction data. For example, the predicted transaction data may include an objective associated with the transaction request, one or more parties associated with the transaction request, a transaction amount, a transaction method, a currency, etc. The training inputs 202 may include a transaction history associated with the one or more accounts associated with the particular user, a transaction history associated with one or more accounts associated with other users, contextual information associated with the one or more accounts associated with the user, and/or third-party data.

The training inputs 202 and the actual outputs 210 may be received from one or more data sources of the system 100. The one or more data sources may include one or more internal data sources (e.g., the memory 112) and/or one or more external data sources (e.g., the user device(s) 130, the third-party database 158, etc.). The one or more internal data sources may be accessible within the provider computing system 102. The one or more external data sources may be accessible over the network 101. For example, the one or more internal data sources may provide account information associated with a user, a transaction history, parameters relating to transactions included in the transaction history (e.g., a timestamp, a transaction type, a transaction amount, a purpose code, one or more parties associated with the transaction, etc.), and so on. The one or more external data sources may provide account information (e.g., stored in the user device(s) 130), contextual information (e.g., retrieved from the third-party database 158), and so on. Thus, the AI model 204 may be trained to predict transaction data based on the training inputs 202 and the actual outputs 210 used to train the AI model 204.

In some embodiments, the AI model 204 may be trained to make one or more recommendations to the user based on current user data received from at least one of the provider computing system 102, the user device(s) 130, and the third-party provider(s) 150. That is, the AI model 204 may be trained using the training inputs 202, such as the transaction history associated with the one or more accounts associated with the user, to predict outputs 206, such as one or more predicted transactions, by applying the current state of the AI model 204 to the training inputs 202. The comparator 208 may compare the predicted outputs 206 to actual outputs 210 (e.g., one or more previous transactions) to determine an amount of error or differences. The actual outputs 210 may be determined based on historic data associated with the recommendation to the user (e.g., data indicating whether the predicted transaction data previously recommended to the user was applied to a transaction or not).

During training, the error (represented by error signal 212) determined by the comparator 208 may be used to adjust the weights in the AI model 204 such that the AI model 204 changes (or learns) over time. The AI model 204 may be trained using a backpropagation algorithm, for instance. The backpropagation algorithm operates by propagating the error signal 212. The error signal 212 may be calculated each iteration, batch and/or epoch, and propagated through the algorithmic weights in the AI model 204 such that the algorithmic weights adapt based on the amount of error. The error is minimized using a loss function. Non-limiting examples of loss functions may include the square error function, the root mean square error function, and/or the cross-entropy error function.

The weighting coefficients of the AI model 204 may be tuned to reduce the amount of error, thereby minimizing the differences between (or otherwise converging) the predicted output 206 and the actual output 210. The AI model 204 may be trained until the error determined at the comparator 208 is within a certain threshold (or a threshold number of batches, epochs, or iterations have been reached). The trained AI model 204 and associated weighting coefficients may subsequently be stored in a memory device or other data repository (e.g., a database) such that the AI model 204 may be employed on unknown data (e.g., not training inputs 202). Once trained and validated, the AI model 204 may be employed during a testing (or an inference phase). During testing, the AI model 204 may ingest unknown data to predict future data (e.g., unprecedented transaction data).

Referring to FIG. 3, a block diagram of a simplified neural network model 300 is shown. The neural network model 300 may include a stack of distinct layers (vertically oriented) that transform a variable number of inputs 302 being ingested by an input layer 304, into an output 306 at the output layer 308.

The neural network model 300 may include a number of hidden layers 310 between the input layer 304 and output layer 308. Each hidden layer has a respective number of nodes (312, 314 and 316). In the neural network model 300, the first hidden layer 310-1 has nodes 312, and the second hidden layer 310-2 has nodes 314. The nodes 312 and 314 perform a particular computation and are interconnected to the nodes of adjacent layers (e.g., nodes 312 in the first hidden layer 310-1 are connected to nodes 314 in a second hidden layer 310-2, and nodes 314 in the second hidden layer 310-2 are connected to nodes 316 in the output layer 308). Each of the nodes (312, 314 and 316) sum up the values from adjacent nodes and apply an activation function, allowing the neural network model 300 to detect nonlinear patterns in the inputs 302. Each of the nodes (312, 314 and 316) are interconnected by weights 320-1, 320-2, 320-3, 320-4, 320-5, 320-6 (collectively referred to as weights 320). Weights 320 are tuned during training to adjust the strength of the node. The adjustment of the strength of the node facilitates the neural network's ability to predict an accurate output 306. Should a user of the system 100 desire a different output, the user can adjust one or more weights to adjust the strength of particular nodes.

In some embodiments, the output 306 may be one or more numbers. For example, output 306 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

With an example structure of system 100 being described above, example processes performable by the system 100 (or components/systems thereof) are described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

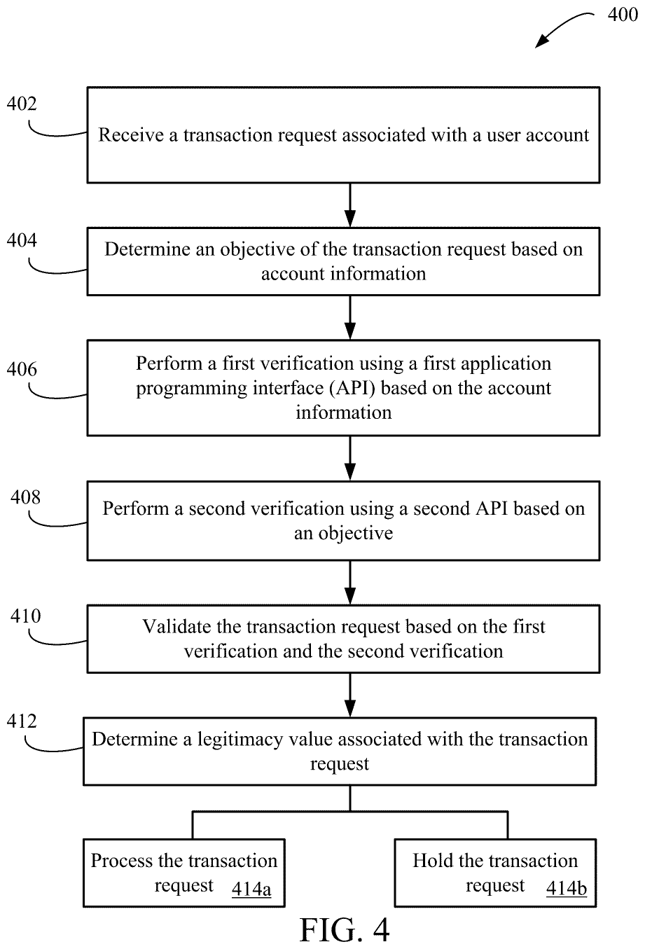

Referring now to FIG. 4, a flow diagram of a method 400 for prevalidating transactions using APIs is shown, according to an example embodiment. In some embodiments, the method 400 is performed or otherwise executed using various components of the system 100.

As shown, method 400 begins when the provider computing system 102 receives a transaction request associated with a user account, at step 402. In some embodiments, the transaction processor 120 may receive the transaction request as an input from the user device 130. For example, a user associated with the user account may launch the client application 136 via the user device 130 and may submit the transaction request via the client application 136. As another example, the transaction processor 120 may receive the transaction request from a schedule of transactions stored in the transaction database 116 and/or otherwise associated with the user account (e.g., stored in the account database 114, the client application 136, the third-party database 158, etc.).

The user account associated with the transaction request may include account information. In some embodiments, the account information may be stored in the account database 114, the memory 140, the third-party database 158, etc. For example, the account information may refer to an entity category (e.g., an industry) associated with the account, an account balance, a transaction history, and so on.

The transaction request received at step 402 may include a plurality of transaction data. The plurality of transaction data refers to one or more parameters used to define the transaction request. For example, the one or more parameters may include a transaction amount, a transaction method, a purpose code, a payor, a payee, a date of completion, and so on. In some embodiments, the plurality of transaction data may be received as an input from the user when the user submits the transaction request. For example, the client application 136 may generate a plurality of input fields in which a user may submit transaction data associated with the transaction request. Alternatively or additionally, the transaction data may be predicted by the AI model 204, as described above with reference to FIGS. 2-3.

In some embodiments, the transaction request may include first transaction data. In this instance, the first transaction data may refer to a transaction amount (e.g., an amount of funds owed by the payor to the payee, where the payor is the user associated with the user account). In some embodiments, the transaction request may include second transaction data. In this instance, the second transaction data may refer to a payee designated to receive the transaction amount indicated by the transaction request.

After receiving the transaction request at step 402, the provider computing system 102 may be configured to determine an objective of the transaction request, at step 404. The objective of the transaction request refers to a purpose of the user for performing the transaction request (e.g., a business purpose, personal spending, etc.). In some embodiments, the objective engine 122 may be configured to determine the objective of the transaction request. The objective engine 122 may determine the objective of the transaction request based on the account information included in the user account associated with the transaction request. For example, the objective engine 122 may determine the objective of the transaction request by identifying an industry (e.g., automobiles) associated with the user account. From the industry associated with the user account, the objective engine 122 may determine a role of the payor within the industry (e.g., an automobile manufacturer) and may determine the objective associated with a transaction request based on the industry and the payor's particular role (e.g., paying a wholesaler for a bulk supply of mechanical parts used in the manufactured automobiles). As another example, the objective engine 122 may identify, from the transaction history associated with the user account, that the payor performs a transfer of a specific amount (e.g., $20) according to a scheduled frequency (e.g., monthly) to a particular account (e.g., a checking account). The objective engine 122 may also identify, from personal information associated with the particular account, that the particular account is held by a minor residing at a same address as the payor. Therefore, in this example, the objective engine 122 may determine the objective based on the transaction history and on personal information associated with the account of the payor and with the account of the payee (e.g., a monthly allowance from a parent to a child).

The method 400 may further include the provider computing system 102 performing a first verification of the transaction request, at step 406. The first verification may include verifying the first transaction data based on the account information. In some embodiments, the first verification may be performed by a first API (e.g., the API(s) 154). For example, the first API may include a balance check API configured to verify that a payor has sufficient funds in the user account in order to perform the transaction request. The balance check API may receive, from the account information associated with the user account (e.g., stored in the account database 114), a current account balance of the user account designated as the payee by the transaction request. The balance check API may then verify that that received account balance of the user account meets or exceeds the transaction amount as designated by the transaction request (e.g., the first transaction data). In this way, the balance check API may be configured to verify whether a payor has sufficient funds for performing a transaction prior to the transaction being performed. In some embodiments, the first API may generate a positive indication of the first verification if the account balance of the user account meets or exceeds the transaction amount as designated by the first transaction data. If the account balance of the user does not meet the transaction amount as designated by the first transaction data, the first API may generate a negative indication of the first verification.

As shown in FIG. 4, the method 400 may include performing a second verification of the transaction request, at step 408. The second verification may include verifying the second transaction data based on the objective determined at step 404. In some embodiments, the second verification may be performed by a second API (e.g., the API(s) 154). For example, the second API may include an API configured to verify the identity of a payee associated with the transaction request. The second API may receive, from the objective engine 122, the objective of the transaction request determined at step 404 of method 400. The second API may then verify that the payee designated by the transaction request (e.g., the second transaction data) relates to the determined objective of the transaction request. In some embodiments, verifying that the payee relates to the objective may include identifying a same industry between the payee and the objective, identifying the payee within a transaction history of transactions associated with the same objective, and so on. For example, if the determined objective is to pay a wholesaler, then a designated payee of a retail boutique does not relate to the determined objective. As another example, if the determined objective is to pay a monthly insurance cost, then a designated payee of an insurance company does relate to the determined objective. In some embodiments, the second API may generate a positive indication of the second verification if the payee designated by the second transaction data relates to the determined objective of the transaction request. If the payee designated by the second transaction data does not relate to the determined objective of the transaction request, the second API may generate a negative indication of the second verification.

Although FIG. 4 is shown to include performing the first verification at step 406 and performing the second verification at step 408, it should be appreciated that the method 400 may include a plurality of steps (e.g., N steps) for performing a plurality of verifications (e.g., N verifications) corresponding to the plurality of transaction data (e.g., N transaction data) associated with a transaction request. For example, if the plurality of transaction data includes a transaction amount, a designated payee, a transaction method, and a date of completion, then method 400 may include a step for performing a verification of the transaction amount, a step for performing a verification of the designated payee, a step for performing a verification of transaction method, and a step for performing a verification of the date of completion. In this example, each step may be performed by an API configured to perform the verification of the transaction amount, an API configured to perform the verification of the designated payee, an API configured to perform the verification of the transaction method, and an API configured to perform the verification of the date of completion, respectively. That is, for N transaction data, the method 400 may include a plurality of N steps for performing N verifications of each of the N transaction data using N corresponding APIs, where N is a whole number (e.g., 1, 5, 12, etc.).

As shown in FIG. 4, the method 400 may include validating the transaction request based on the first verification and the second verification, at step 410. Where the method 400 includes N steps for performing N verifications, step 410 may include validating the transaction request based on the N verifications. In some embodiments, step 410 may be performed by the validation engine 124. The validation engine 124 may receive the first verification (e.g., the verification of the transaction amount) and the second verification (e.g., the verification of the payee) from the respective APIs (e.g., APIs 154). In some embodiments, the validation engine 124 may receive the positive indication of the first verification or the negative indication of the first verification from the first API. The validation engine 124 may also receive the positive indication of the second verification or the negative indication of the second verification from the second API. In some embodiments, if the validation engine 124 receives the positive indication of the first verification and the positive indication of the second verification, the validation engine 124 may be configured to instruct the provider computing system 102 to process the transaction request (e.g., as described below with reference to step 414a of method 400). Alternatively or additionally, if the validation engine 124 receives the negative indication of the first verification and/or the negative indication of the second verification, the validation engine 124 may be configured to instruct the provider computing system 102 to hold the transaction request (e.g., as described below with reference to step 414b of method 400).

In some embodiments, as shown in FIG. 4, the method 400 may optionally include determining a legitimacy value associated with the transaction request, at step 412. The legitimacy value refers to a value representative of the verification of the transaction data associated with the transaction request. The validation engine 124 may be configured to determine the legitimacy value in order to validate the transaction request. In some embodiments, the legitimacy value includes a score (e.g., a number, a letter, a category, etc.) out of a predefined scale. The predefined scale may be determined by the provider institution and encoded into the validation engine 124. The predefined scale may include any of a numerical range (e.g., 0-10, 0-100, etc.), an alphabetical range (e.g., A, B, C, D, or F), a categorical range (e.g., very good, good, neutral, bad, very bad), and so on.

For example, if the validation engine 124 receives the positive indication of the first verification and the positive indication of the second verification, the validation engine 124 may be configured to determine a highest legitimacy value (e.g., 5, 10, 100, A, very good, etc.) on the predefined scale. As another example, if the validation engine 124 receives the positive indication of the first verification and the negative indication of the second verification, the validation engine 124 may be configured to determine a middle legitimacy value (e.g., 5, 50, C, neutral, etc.) on the predefined scale. As yet another example, if the validation engine 124 receives the negative indication of the first verification and the negative indication of the second verification, the validation engine 124 may be configured to determine a lowest legitimacy value (e.g., 0, F, very bad, etc.) on the predefined scale.

In some embodiments, the validation engine 124 may be configured to compare the determined legitimacy value with a threshold legitimacy value. The threshold legitimacy value refers to a legitimacy value that must be met or surpassed in order for a transaction to be validated. In some embodiments, the threshold legitimacy value may be defined by the provider computing system 102. For example, the provider institution may implement one or more operational guidelines that require transactions to be verified prior to processing. In this instance, the validation engine 124 may retrieve the threshold legitimacy value from the memory 112. In some embodiments, the threshold legitimacy value may be defined by a user of the user device 130. For example, the user may have an account at the provider institution and may designate one or more account preferences that require transactions associated with the account to be verified prior to processing. In this instance, the validation engine 124 may retrieve the threshold legitimacy value from the account database 114, the client application 136, the memory 140, and so on. In still other embodiments, the threshold legitimacy value may be defined by the third-party provider 150. For example, if the third-party provider 150 is a transfer service, the transfer service may require that providers and/or users who perform transactions using the transfer service verify any transaction being performed using the transfer service. In this instance, the validation engine 124 may retrieve the threshold legitimacy value from the third-party database 158.

After the validation engine 124 identifies the threshold legitimacy value, the validation engine 124 may be configured to compare the determined legitimacy value with the threshold legitimacy value. For example, if transfer service desires strict security measures against incoming transactions, the threshold legitimacy value defined by the transfer service may be a highest legitimacy value on the predefined scale (e.g., 10, 100, A, very good, etc.). Therefore, the validation engine 124 may identify whether the determined legitimacy value is the highest legitimacy value on the pre-defined scale.

Based on the legitimacy value determined at step 412, method 400 may include processing the transaction request at step 414a or holding the transaction request at step 414b. Processing the transaction request at step 414a may include performing the transaction request as defined by the transaction data. For example, processing the transaction request may include withdrawing the transaction amount from a payor's account and transferring the transaction amount to a payee on the designated date of completion using the transaction method as instructed by the transaction data. In some embodiments, processing the transaction request may include instructing a third-party provider 150 (e.g., a transfer service) to process the transaction request according to the transaction data. For example, if the validation engine 124 determines that the legitimacy value determined at step 412 of method 400 meets the threshold legitimacy value, the provider computing system 102 (e.g., the transaction processor 120) may be configured to process the transaction requestion.

Alternatively, holding the transaction request at step 414b may include failing to process the transaction request. For example, if the validation engine 124 determines that the legitimacy value determined at step 412 of method 400 fails to meet the threshold legitimacy value, the provider computing system (e.g., the transaction processor 120) may be configured to hold the transaction request. In some embodiments, upon failing to process the transaction request, the provider computing system 102 may be configured to store the held transaction request in a transaction queue (e.g., in the transaction database 116). The transaction queue may include an ordering of transactions that have been held based on an insufficient verification of the transaction data. In some embodiments, a user associated with the held transaction request may be prompted by the provider computing system (e.g., via a push notification, an email, a text message, and so on, to the user device 130 via the client application 136) to manually verify and/or modify the transaction data. For example, if a designated payee does not relate to a determined objective of the transaction request, the transaction request may be held in the transaction queue and the payor may be prompting to verify and/or modify the designated payee on the transaction request. After receiving a verification and/or modification to the transaction data from the user, the provider computing system 102 and/or the third-party provider 150 may be configured to process the transaction request, as described above with reference to step 414a.

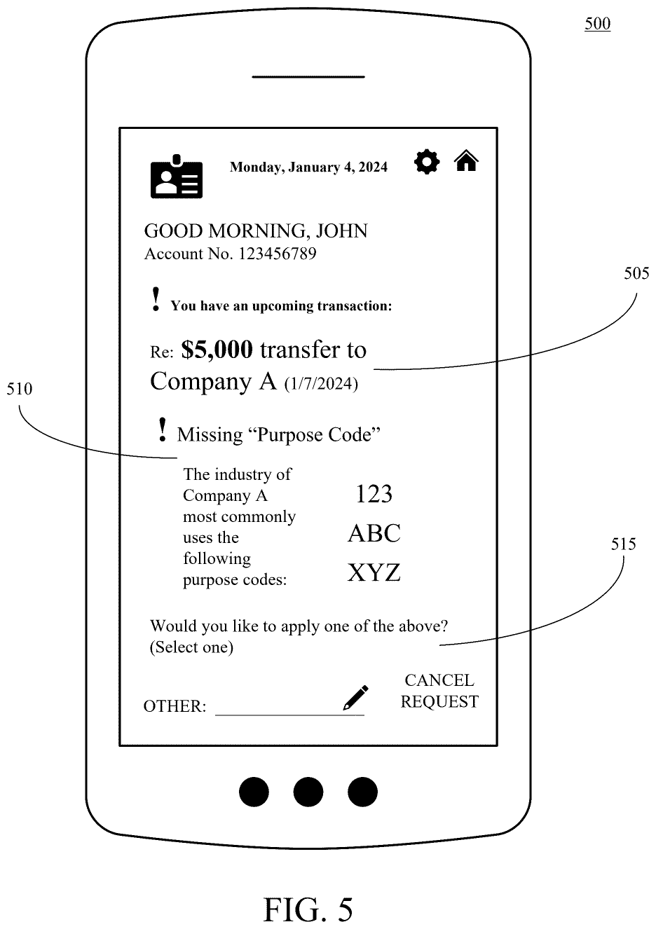

Referring to FIG. 5, a GUI 500 for displaying a prevalidation of a transaction request using APIs is shown. The GUI 500 may be configured to be displayed to a user of the user device 130 via the client application 136 during a client application session (e.g., while the user of the user device 130 has successfully launched and accessed/logged in to the client application 136). The GUI 500 may be presented to the user of the user device 130 after identifying an upcoming transaction request (e.g., from the transaction database 116) associated with the user that may be missing validation of transaction data associated with the transaction request (e.g., a purpose code, a payee, a transaction amount, a transaction method, a date of completion, and so on). The GUI 500 may include a display of an upcoming transaction 505, a display of missing transaction data 510, and an option to validate 515.

In some embodiments, the display of the upcoming transaction 505 refers to a display of the transaction request received at step 402 of method 400. In some embodiments, the provider computing system 102 may identify the upcoming transaction from a scheduled of transactions stored in the transaction database 116. In some embodiments, the provider computing system 102 may receive the transaction request as an input from the user of the user device 130 via the client application 136. In still other embodiments, the provider computing system 102 may receive the transaction request from the third-party provider 150 (e.g., another provider institution, a transfer service, etc.). The display of the upcoming transaction 505 may include a display of the transaction data used to define the transaction request. For example, the display of the upcoming transaction 505 may include a transaction amount (e.g., $5,000), a payee (e.g., “Company A”), and a date of completion (e.g., Jan. 7, 2024).

The GUI 500 may also include the display of the missing transaction data 510. The display of the missing transaction data 510 refers to transaction data that has not been defined by the transaction request (e.g., transaction data that is not included in the display of the upcoming transaction 505). For example, the display of the missing transaction data 510 may identify that the upcoming transaction does not define a purpose code associated with the transaction. In some embodiments, an API (e.g., a purpose code API) may be used to identify one or more purpose codes that may relate to the transaction based on at least one of account information associated with the transaction or a determined objective associated with the transaction (e.g., the objective determined at step 404 of method 400, as described above). For example, the purpose code API may identify that the payee (e.g., “Company A”) operates within a specific industry. The purpose code API may then identify (e.g., from a transaction history associated with Company A stored in the transaction database 116, from third-party data stored in the third-party database 158 relating to the industry, etc.), one or more purpose codes that are commonly applied to transactions between a payor and Company A. Therefore, provider computing system 102 may display the one or more purpose codes as suggestions to the user via the GUI 500.

In some embodiments, the one or more suggested purpose codes may be presented as selectable elements such that the GUI 500 includes the option to validate 515. In this way, the user of the user device 130 may click on/engage with one of the selectable elements to validate a purpose code associated with the transaction. That is, upon receiving a validation of the purpose code associated with the transaction, the provider computing system 102 may store the validation of the purpose code in association with the upcoming transaction (e.g., in the transaction database 116) such that the purpose code is prevalidated and does not require further verification on the date of completion of the transaction. Alternatively or additionally, the option to validate 515 may include an input field (e.g., a text box) where the user may submit a purpose code that is not included as a suggested purpose code on the GUI 500. As shown in FIG. 5, the GUI 500 may further include an option for the user to cancel the transaction request.

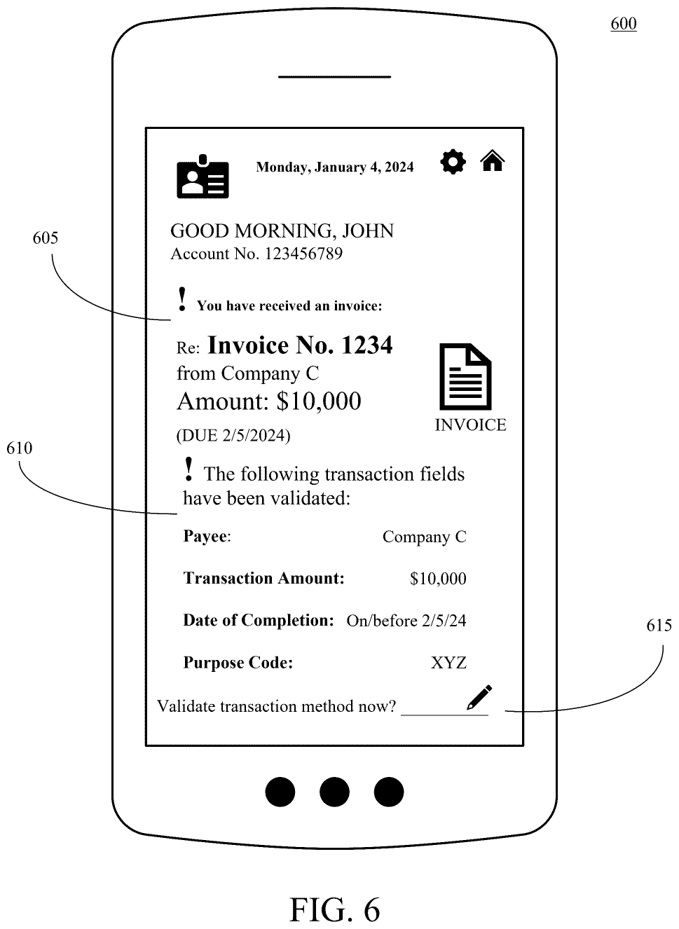

Referring to FIG. 6, a GUI 600 for displaying a prevalidation of a transaction request using APIs is shown. The GUI 600 may be configured to be displayed to a user of the user device 130 via the client application 136 during a client application session (e.g., while the user of the user device 130 has successfully launched and accessed/logged in to the client application 136). The GUI 600 may be presented to the user of the user device 130 after receiving an invoice (e.g., from the third-party database 158) associated with the user that may be used to validate transaction data associated with the transaction request (e.g., a purpose code, a payee, a transaction amount, a transaction method, a date of completion, and so on). The GUI 600 may include a display of the received invoice 605, a display of the validated transaction data 610, and an option to validate missing transaction data 615.

In some embodiments, the display of the received invoice 605 refers to a display of an invoice associated with an account from which the client application 136 is accessed. In some embodiments, the invoice may be received by the provider computing system 102 from a third-party provider (e.g., third-party provider 150). For example, the third-party provider 150 may be a wholesale provider that conducts business with a manufacturer. In this example, the wholesale provider may provide an invoice to the provider computing system 102 that designates the manufacturer by one or more account credentials (e.g., an account number, an account name a routing number, or any other identifier). Upon receiving the invoice, the provider computing system 102 may be configured to notify the user associated with an account designated on the invoice via the client application 136 (e.g., by sending a push notification, a text message, an email message, etc.). The provider computing system 102 may then generate the GUI 600 including the display of the received invoice 605.

In some embodiments, the display of the received invoice 605 may include one or more parameters associated with the invoice. For example, the one or more parameters may include an invoice number (e.g., “Invoice No. 1234”), a sending party (e.g., “Company C”), an amount due (e.g., $10,000), a due date (e.g., Feb. 5, 2024), and so on. In some embodiments, the display of the received invoice 605 may further include a selectable element configured to provide the invoice when engaged with/clicked on by the user. For example, after a user clicks on the selectable element, the user device 130 may be configured to display a document (e.g., a PDF, an email correspondence, or any other document type) of the invoice.

The GUI 600 may also include the display of the validated transaction data 610. The display of the validated transaction data 610 refers to any of the one or more parameters associated with the invoice that may be applied to a transaction request. That is, the provider computing system 102, via one or more APIs, may be configured to prevalidate a transaction that includes transaction data that is the same as the one or more parameters associated with the invoice. For example, based on the one or more parameters associated with the invoice, as described above, the provider computing system 102 may identify a payee (e.g., “Company C”), a transaction amount (e.g., $10,000), a date of completion (e.g., on or before Feb. 5, 2024), and a purpose code (e.g., “XYZ”). Each of the payee, the transaction amount, the date of completion, and the purpose code may be included in the display of the validated transaction data 610, as shown in FIG. 6.

As shown in FIG. 6, the GUI 600 may include the option to validate missing transaction data 615. The option to validate missing transaction data 615 may be presented via the GUI 600 based on transaction data that may be required of a transaction request but that is not provided by the received invoice. For example, although the provider computing system 102 may identify a payee, a transaction amount, a date of completion, and a purpose code from the received invoice, a transaction method may not be provided by the invoice. Therefore, the provider computing system 102 may present, to the user via the GUI 600, an option to submit a transaction method such that the transaction method of an upcoming transaction related to the invoice may be a validated transaction method.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f) unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general-purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, a joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A provider computing system comprising:
a processing circuit having a processor coupled to a memory device, the memory device storing instructions thereon that, when executed, cause the processing circuit to perform operations comprising:
receiving a transaction request from a user device associated with a user account held by a provider associated with the provider computing system, wherein the user account comprises account information, and the transaction request comprises first transaction data and second transaction data;
determining an objective of the transaction request based on the account information;
performing a first verification comprising verifying, using a first application programming interface (API), the first transaction data based on the account information;
performing a second verification comprising verifying, using a second API, the second transaction data based on the objective; and
validating the transaction request based on the first verification and the second verification.

2. The provider computing system of claim 1, wherein the operations further comprise:
training an artificial intelligence (AI) model; and
predicting, using the trained AI model, at least one of the objective, the first transaction data, or the second transaction data.

3. The provider computing system of claim 2, wherein the AI model comprises a generative AI model and wherein the provider computing system is further configured to store the at least one of the predicted objective, the predicted first transaction data, or the predicted second transaction data as training data for the generative AI model.

4. The provider computing system of claim 1, wherein validating the transaction request further comprises:
determining a legitimacy value associated with the transaction request;
comparing the legitimacy value with a threshold legitimacy value; and
at least one of:
processing the transaction request if the legitimacy value associated with the transaction request meets the threshold legitimacy value; or
holding the transaction request if the legitimacy value associated with the transaction request fails to meet the threshold legitimacy value.

5. The provider computing system of claim 1, wherein the first transaction data comprises a transaction amount.

6. The provider computing system of claim 5, wherein the first API is further configured to:
receive, from the account information, an account balance associated with the user account; and
verify the received account balance with the transaction amount identified by the transaction request.

7. The provider computing system of claim 1, wherein the second transaction data comprises a payee.

8. The provider computing system of claim 7, wherein the second API is further configured to:
receive the determined objective of the transaction request; and
verify the determined objective with the payee identified by the transaction request.

9. The provider computing system of claim 1, wherein the transaction request comprises a plurality of transaction data, and wherein the operations further comprise:
performing a plurality of verifications comprising verifying, using a plurality of APIs, the plurality of transaction data.

10. The provider computing system of claim 1, wherein the account information comprises at least one of an entity category associated with the user account, an account balance, or a transaction history.

11. A method comprising:
receiving, by a provider computing system, a transaction request from a user device associated with a user account held by a provider associated with the provider computing system, wherein the user account comprises account information, and the transaction request comprises first transaction data and second transaction data;
determining, by the provider computing system, an objective of the transaction request based on the account information;
performing, by the provider computing system, a first verification comprising verifying, using a first application programming interface (API), the first transaction data based on the account information;
performing, by the provider computing system, a second verification comprising verifying, using a second API, the second transaction data based on the objective; and
validating, by the provider computing system, the transaction request based on the first verification and the second verification.

12. The method of claim 11, the method further comprising:
training, by the provider computing system, an artificial intelligence (AI) model; and
predicting, by the provider computing system using the trained AI model, at least one of the objective, the first transaction data, or the second transaction data.

13. The method of claim 12, wherein the AI model comprises a generative AI model and wherein the provider computing system is further configured to store the at least one of the predicted objective, the predicted first transaction data, or the predicted second transaction data as training data for the generative AI model.

14. The method of claim 11, wherein validating the transaction request further comprises:
determining, by the provider computing system, a legitimacy value associated with the transaction request;
comparing, by the provider computing system, the legitimacy value with a threshold legitimacy value; and
at least one of:
processing, by the provider computing system, the transaction request if the legitimacy value associated with the transaction request meets the threshold legitimacy value; or
holding, by the provider computing system, the transaction request if the legitimacy value associated with the transaction request fails to meet the threshold legitimacy value.

15. The method of claim 11, wherein the first transaction data comprises a transaction amount and wherein the second transaction data comprises a payee.

16. The method of claim 15, wherein the first API is further configured to:
receive, by the provider computing system and from the account information, an account balance associated with the user account; and
verify, by the provider computing system, the received account balance with the transaction amount identified by the transaction request.

17. The method of claim 15, wherein the second API is further configured to:
receive, by the provider computing system, the determined objective of the transaction request; and
verify, by the provider computing system, the determined objective with the payee identified by the transaction request.

18. The method of claim 11, wherein the transaction request comprises a plurality of transaction data, the method further comprising:
performing a plurality of verifications comprising verifying, using a plurality of APIs, the plurality of transaction data.

19. The method of claim 11, wherein the account information comprises at least one of an entity category associated with the user account, an account balance, or a transaction history.

20. A non-transitory computer-readable medium storing instructions that, when executed, cause a processing circuit to:
receive a transaction request from a user device associated with a user account held by a provider associated with a provider computing system, wherein the user account comprises account information, and the transaction request comprises first transaction data and second transaction data;
determine an objective of the transaction request based on the account information;
perform a first verification comprising verifying, using a first application programming interface (API), the first transaction data based on the account information;
perform a second verification comprising verifying, using a second API, the second transaction data based on the objective; and
validate the transaction request based on the first verification and the second verification.
